(19) United States
(12) Patent Application Publication
(10) Pub. No.: US 2018/0283359 A1
(43) Pub. Date: Oct. 4, 2018

(54) A SYSTEM AND METHOD FOR RAISING AND LOWERING A COMPONENT OF A WIND TURBINE

(71) Applicant: WINDCARE INDIA PVT LTD, Tamil Nadu (IN)

(72) Inventor: Anthonyraj Prem Kumar SENTHOORPANDIAN, Tamil Nadu (IN)

(21) Appl. No.: 15/764,912

(22) PCT Filed: Oct. 5, 2016
(86) PCT No.: PCT/IB16/55949

§ 371 Date: Mar. 30, 2018

(30) Foreign Application Priority Data
Oct. 9, 2015 (IN) 5424/CHE/2015

(51) Int. Cl. F03D 80/50; B66D 1/60

(52) U.S. Cl. CPC F03D 80/50; B66D 2700/026; F05B 2240/916; B66D 1/60

(57) ABSTRACT

The present disclosure discloses a system for raising from and lowering to the ground level a component of a wind turbine to and from a nacelle mounted on a tower. The system includes a winch system which is disposed on ground in the vicinity of the tower, a first pulley which is fitted at the base of the tower, a derrick structure which is fitted in the nacelle, a pulley system, a jig and a rope. The pulley system includes a set of fixed pulleys fitted to derrick structure and a set of movable pulleys fitted to fixed pulleys and is also coupled to the jig which holds the component. The rope is wound in the winch system and coiled around the first pulley, the set of fixed pulleys and movable pulleys and secured in a securing element fixed to the derrick structure proximal to the set of fixed pulleys.

### FIELD

The present disclosure relates to the field of mechanical engineering. In particular, the present disclosure relates to wind turbines.

### BACKGROUND

Generally, a wind turbine comprises a tower, a nacelle that houses and supports an electricity generation system and a rotor assembly fitted to the electric generation system. The tower is disposed on a foundation foot. The tower may be formed by assembling a plurality of tower sections that are assembled with each other by flange and bolt arrangements to form a tower of the desired height. The tower may be a freestanding tubular tower, a freestanding lattice tower or a freestanding lattice cum tubular tower.

The nacelle is mounted on the tower and houses an electricity generation system. The electricity generation system comprises, a gearbox, an electric generator and a transformer. The gearbox is connected to the electric generator. The transformer is connected at the output end of the electric generator. The rotor assembly includes a shaft, a rotor and rotor blades/vanes. The shaft is connected to the electricity generation system. The rotor is fitted on one end of the shaft and the rotor blades/vanes extend from the rotor. The atmospheric wind impinges the rotor blade/vanes that cause the rotation of the rotor, and hence the rotation of the shaft. The rotation of the shaft actuates the electricity generation system that produces electricity. In one embodiment, a yaw system is disposed between the nacelle and the tower for orienting the nacelle. The yaw system has a yaw brake that can stop the nacelle in a particular orientation. A nacelle is sometimes also fitted with a nacelle hoist that enables lifting up of materials from the ground to the nacelle. Alternatively, materials may be lifted manually. Material may be required to be carried from the ground to the nacelle during maintenance of the wind turbine. The nacelle has a nacelle cover that may be opened for accessing the interior of the nacelle.

Further, a wind turbine comprises a control panel that is corporates with the electricity generation system. Additionally, a wind vane with an anemometer may be disposed on the nacelle.

In case if any fault is detected in any component(s) of the rotor assembly, the gearbox, the electric generator, the transformer, the component(s) needs to be repaired or replaced. Conventionally, cranes are required to raise and lower the faulty component(s), that are heavy and bulky, from the ground to the nacelle of the wind turbine. However, the use of cranes is feasible only where the wind turbine is situated at a location where it is easy for the cranes to reach. In case where the wind turbines are located in hilly areas or located in remote locations which are difficult to access, the use of crane for repair or replacement of the faulty component(s) is comparatively difficult. Also, the cost associated with sending the cranes at the wind turbine location is very high. In case where a single faulty component of the wind turbine has to be repaired or replaced, the use of a crane is not economically feasible.

Hence, in order to overcome the aforementioned drawbacks, there is a need for a system and a method to install various components of the wind turbine without the use of a crane.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a system for raising and lowering a component of a wind turbine without usage of a crane.

Another object of the present disclosure is to provide a system for raising and lowering a component of a wind turbine that is comparatively less capital intensive.

Other objects and advantages of the present disclosure will be more apparent from the following description, which is not intended to limit the scope of the present disclosure.

### SUMMARY

The present disclosure discloses a system for raising from and lowering to the ground level a component of a wind turbine to and from a nacelle mounted on a tower. The system includes a winch system, a first pulley, a derrick structure, a pulley system, a jig and a rope. The winch system is disposed on the ground in the vicinity of the tower. The first pulley is configured to be fitted at the base of the tower. The derrick structure configured to be fitted in the nacelle. The pulley system includes a set of fixed pulleys and a set of movable pulleys. The set of fixed pulleys is configured to be fitted to the derrick structure. The set of movable pulleys is configured to be fitted to the fixed pulleys. The jig is configured to be coupled to the set of movable pulleys. The jig is configured for holding the component. The rope is wound around a drum of the winch system and coiled around the first pulley, the set of fixed pulleys, the set of movable pulleys and secured to a securing element fixed configured on the derrick structure proximal to the set of fixed pulleys.

The present disclosure also discloses a method for raising from and lowering to the ground level a component of a wind turbine to and from a nacelle mounted on a tower. The method comprises fixing a winch system on the ground, fixing the derrick structure within the nacelle, mounting a first pulley on the base of the tower, mounting a set of fixed pulleys on the derrick structure, connecting a rope between the winch system, the first pulley, the set of fixed pulleys and a set of movable pulleys, fixing a jig to the set of movable pulleys, fixing the component on the jig and actuating the winch system for drawing in and drawing out the rope, thereby raising from and lowering to the ground level said movable pulley, the jig and the component to and from the nacelle.

### BRIEF DESCRIPTION OF ACCOMPANYING DRAWING

A system for raising and lowering a component of a wind turbine in accordance with the present disclosure will now be described with the help of the accompanying drawing, in which:

FIG. 1 illustrates a perspective view of a wind turbine;

FIG. 2 illustrates a perspective view of a nacelle of the wind turbine of FIG. 1 that supports an electricity generation system of the wind turbine of FIG. 1;

FIG. 3 illustrates a schematic view of a system for raising and lowering a component of a wind turbine to be fitted in the wind turbine of FIG. 1, in which the tower of the wind turbine is a freestanding tubular tower;

FIG. 4 illustrates a schematic view of the system of FIG. 3, in which the tower of the wind turbine is a freestanding lattice tower;

FIG. 5 illustrates a schematic view of the system of FIG. 3, in which the tower of the wind turbine is a freestanding lattice cum tubular tower;

FIG. 6 illustrates a schematic representation of a winch system of the system of FIG. 3 fitted on the ground;

FIG. 7a to FIG. 7b illustrates a schematic representation of a winch system disposed in the vicinity of the wind turbine of FIG. 1 and a first pulley securing element of the system of FIG. 3 fitted on the base of the tower of the wind turbine of FIG. 1;

FIG. 8 illustrates a schematic representation of a derrick structure of the system of FIG. 3 fitted in the nacelle of FIG. 2;

FIG. 9 illustrates a perspective view of the derrick structure of FIG. 8;

FIG. 10 illustrates a schematic representation of the system of FIG. 3;

FIG. 11a and FIG. 11b illustrates a schematic representation of a set of movable pulleys connected to a set of movable pulleys of the system of FIG. 3;

FIG. 12 and FIG. 13 illustrates a schematic representation of a jig of the system of FIG. 3 disposed near the nacelle of FIG. 2; and

FIG. 14 illustrates a schematic representation of an anti-swaying mechanism of the system of FIG. 3 secured by operator personnels.

### DETAILED DESCRIPTION

The disclosure will now be described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

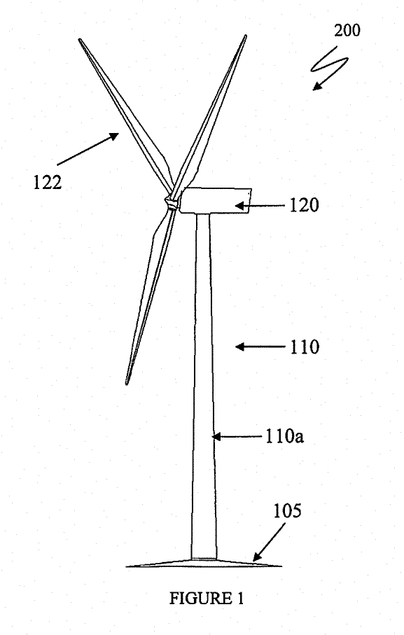

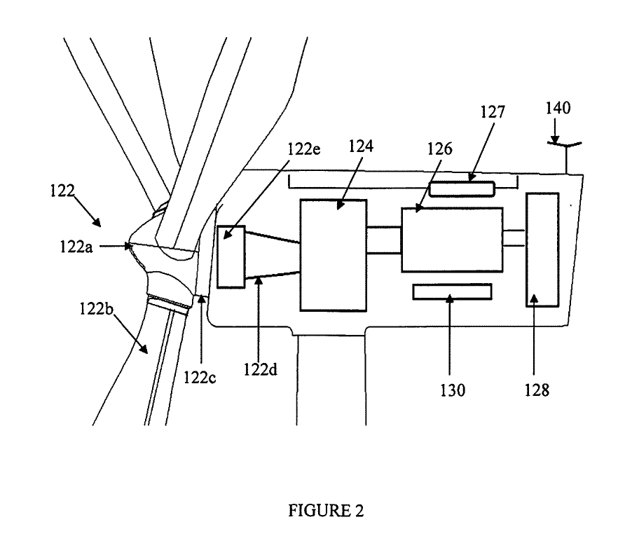

FIG. 1 illustrates a typical wind turbine 200. The wind turbine 200 comprises a tower 110, a nacelle 120, and a rotor assembly 122. In accordance with one embodiment, the wind turbine 200 further includes a yaw system (not illustrated in Figures), a yaw brake (not illustrated in Figures), a rotor brake (not illustrated in Figures) and a nacelle hoist 127 (as illustrated in FIG. 2).

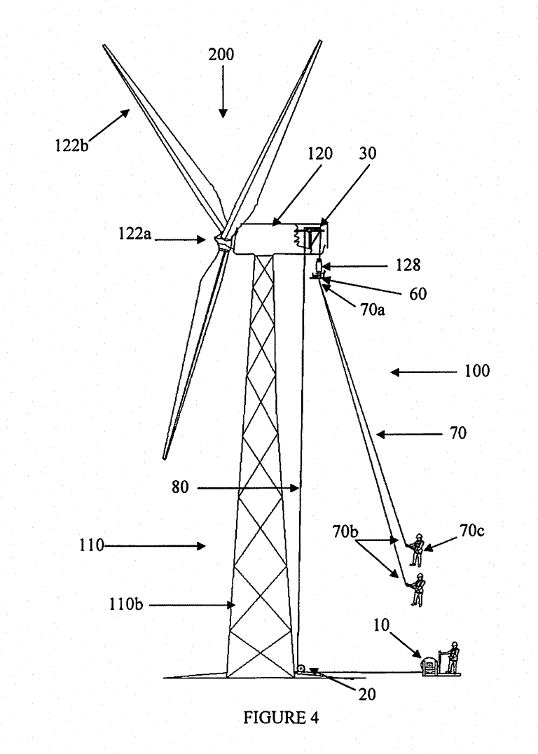

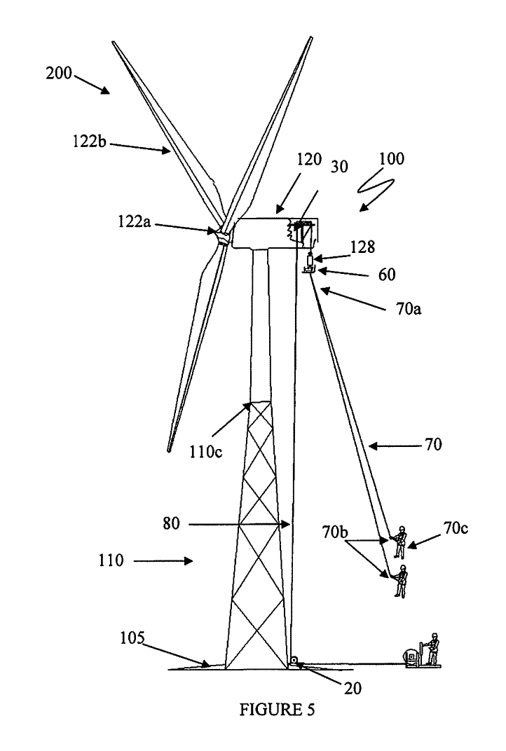

The tower 110 is disposed on a foundation foot 105. The tower 110 may be formed by assembling a plurality of tower sections (not illustrated in Figures) that are assembled with each other by flange and bolt arrangements to form a tower of the desired height. The tower 110 may be a freestanding tubular tower 110a (as illustrated in FIG. 1), a freestanding lattice tower 110b (as illustrated in FIG. 4) or a freestanding lattice cum tubular tower 110c (as illustrated in FIG. 5)

The nacelle 120 is mounted on the tower 110 and supports an electricity generation system (also known as a processing unit power). The electricity generation system comprises a gearbox 124 (illustrated in FIG. 2), an electric generator 126 (illustrated in FIG. 2), and a transformer 128 (illustrated in FIG. 2). The rotor assembly 122 includes a rotor 122a, rotor blades/vanes 122b connected to the rotor 122a, a hub 122c, a shaft 122d connected to the electricity generation system and bearings 122e. The atmospheric wind impinges the rotor blades/vanes 122b that causes the rotation of the rotor 122a, and hence the shaft 122d. The rotation of the shaft 122d actuates the electric generator 126 that produces electricity. The gearbox 124 is coupled to the electric generator 126. The transformer 128 is connected at the output end of the electric generator 126. In one embodiment, the yaw system is disposed between the nacelle 120 and the tower 110 for orienting the nacelle 120. The yaw system has a yaw brake that can stop the nacelle 120 at a particular orientation. The nacelle 120 may also be fitted with the nacelle hoist 127 that facilitates the lifting of materials from the ground level to the nacelle 120. Material may be required to be carried from the ground level to the nacelle 120 during maintenance of the wind turbine 200. The nacelle 120 has a nacelle cover 120a that may be opened for accessing the interior of the nacelle 120.

Further, the wind turbine 200 comprises a control panel 130 that co-operates with the electricity generation system. Additionally, a wind vane 140 with an anemometer (not illustrated in Figures) may be disposed on the nacelle 120.

During operation of the wind turbine 200, there may be an occurrence where one or more components may fail. For example, the transformer 128 may fail due to lighting/electricity surges, overloading, loose connection, breakdown, line surges, inadequate maintenance, moisture, contaminated oil, deterioration of insulation, poor workmanship, sabotage, manufacturer failure, various technical failure or other natural calamities or other causes. Hence, there is a need to repair or replace components like the transformer 128.

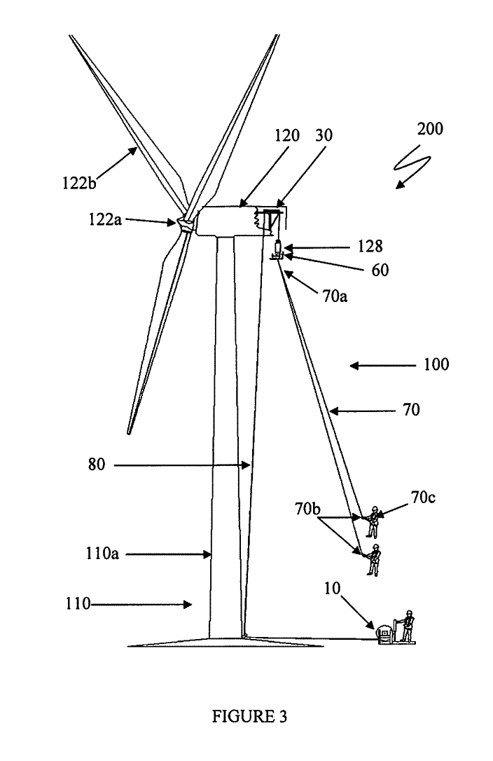

In accordance with one embodiment of the present disclosure, the system 100 (illustrated in FIGS. 3, 4 and 5) for raising from and lowering to the ground level a component, such as the transformer 128, of the wind turbine 200 to and from the nacelle 120 is disclosed. Although the present disclosure illustrates raising and lowering of the transformer 128, however, the present disclosure is not limited to raising and lowering of the transformer 128, and any component(s) that may require repair and maintenance may be raised or lowered from the ground level to the nacelle and vice-versa.

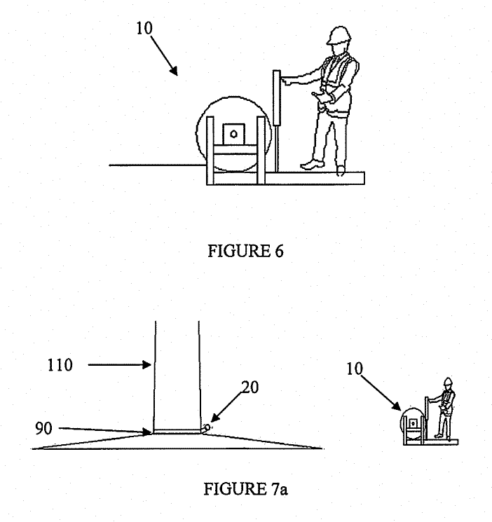

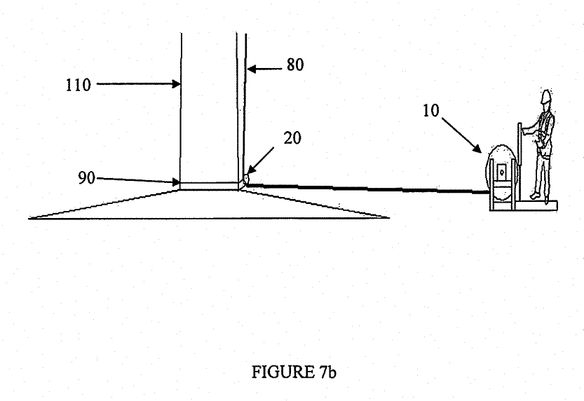

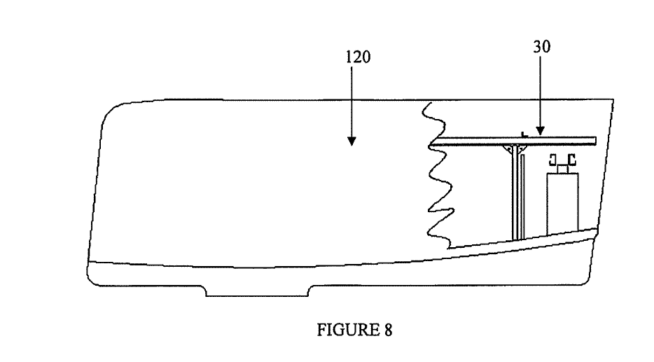

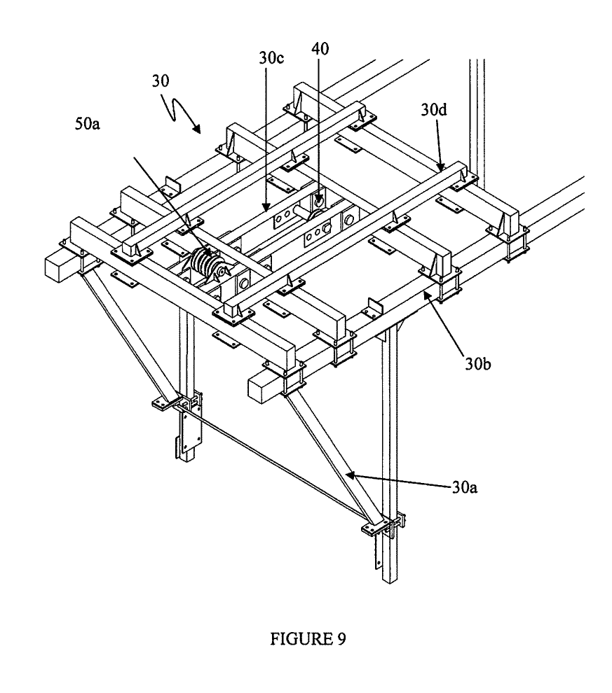

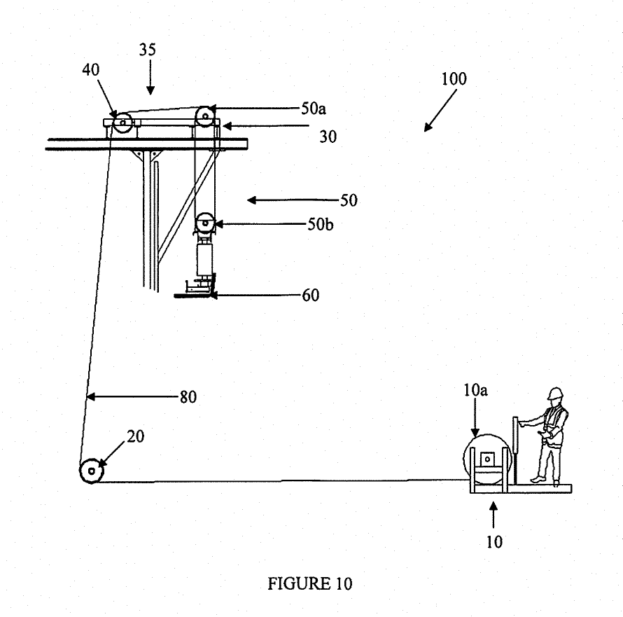

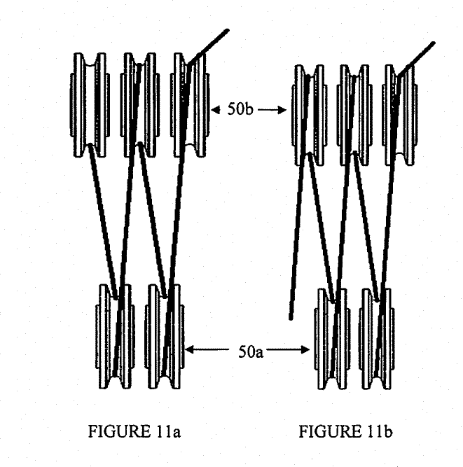

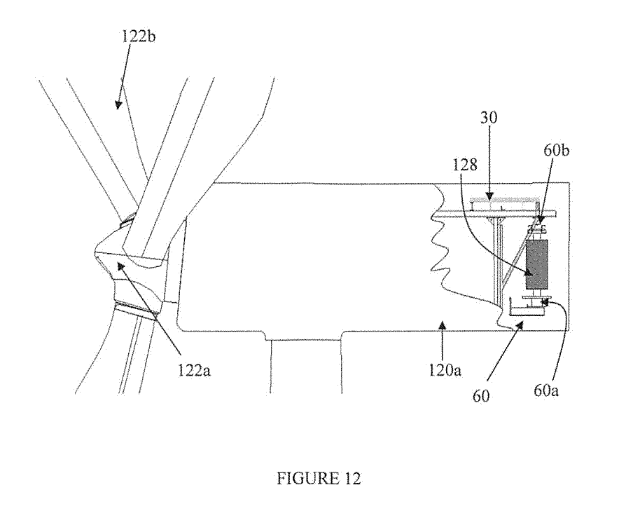

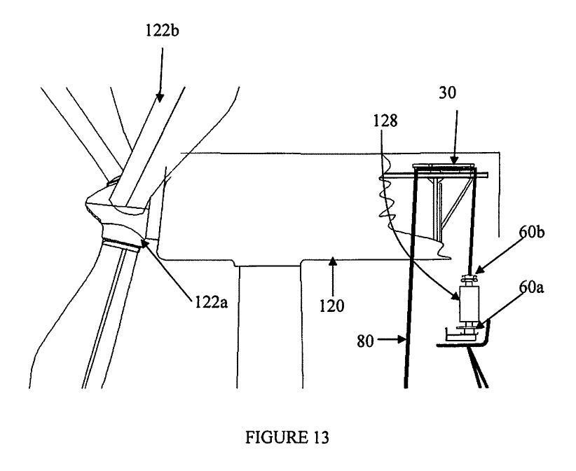

In an exemplary embodiment, the system 100 comprises a winch system 10 (illustrated in FIG. 6), at least one first pulley 20 (illustrated in FIGS. 7a and 7b), a derrick structure 30 (illustrated in FIGS. 8 and 9), a pulley system 35 (illustrated in FIGS. 10, 11a and 11b) and a jig 60 (illustrated in FIGS. 12 and 13) and a rope 80.

The winch system 10 (illustrated in FIG. 10) is detachably fitted on ground in the vicinity of the tower 110 and draws in and draws out the rope 80. The winch system 10 has a drum 10a, the rotation of which enables winding to draw in and un-winding to draw out the rope 80. The winch system 10 is easy to transport in remote or hilly areas where the wind turbine is mounted. The winch system 10 has large power to size ratio. The winch system 10 is easily installed on the ground by driving at least one peg (not illustrated in Figures) into the ground through a platform 10b. The winch system 10 has counter weights (not illustrated in Figures), typically in form of concrete blocks or metallic blocks. The key purpose of the pegs and counter blocks or metallic block is to avoid slip and sliding of the winch system 10 during operative configuration. The winch system 10 may be manually operated or automatically operated by mechanical, hydraulic or pneumatic systems. In an in-operative configuration, the winch system 10 is easily removed from the ground and may be then transported at other locations.

The first pulley 20 (illustrated in FIGS. 7a and 7b) is detachably fitted at the base of the tower 110. The first pulley 20 is configured with a first grooved rim (not illustrated in Figures) that guides the rope 80 during the draw in and draw out of the rope 80 during operative configuration of the winch system 10. In accordance with one embodiment, a first pulley securing element (also known as tower bottom jig) 90 is provided at the base of the tower 110 for securing the first pulley 20. Typically, the first pulley securing element 90 is a ring like element which is either circular in shape or an L-shaped structure or rectangular shaped structure or angular shaped structure. Typically, the first pulley securing element 90 is made of steel. The type and size of the first pulley securing element 90 is dependant on various factors such as the circumference of the base of the tower 110, the load to be balanced by the first pulley 20 and the like. Also, the first pulley securing element 90 may be easily and conveniently attached and released from the tower 110. Typically, the first pulley securing element 90 may be clamped around the tower 110 and fastened with bolts or pins. The first pulley securing element 90 is easily removable from the tower 110.

The derrick structure 30 (illustrated in FIGS. 8 and 9) is mounted within the nacelle 120. In accordance with one embodiment, the derrick structure 30 comprises a plurality of leg post 30a, a top beam 30b, at least a pair of H-shaped cross beams 30c and a pair of purlins 30d. The plurality of leg post 30a is secured within the nacelle 120. The top beam 30b is supported and secured to the leg post 30a. The H-shaped cross beams 30c are transversely secured to the top beam 30b. The pair of purlins 30d is transversely secured to the of H-shaped cross beams 30c. In one embodiment, the leg post 30a, the top beam 30b, the H-shaped cross beams 30c, and the purlins 30d are secured by nut and bolt arrangements.

The pulley system 35 includes a set of fixed pulleys and a set of movable pulleys. The fixed pulleys include at least one second pulley 40 and at least one third pulley 50a. The second pulley 40 is secured between the H-shaped cross beams 30c of the derrick structure 30 such that the second pulley 40 is disposed substantially vertically in line with the first pulley 20 and guides the rope 80 that is received from the first pulley 20. The second pulley 40 is easily removable from the H-shaped cross beams 30c of the derrick structure 30.

The set of movable pulleys includes at least one fourth pulley 50b. The fourth pulley 50b forms a tackle arrangement with the third pulley 50a. The third pulley 50a is secured in the H-shaped cross beams 30c of the derrick structure 30 such that one of the third pulley 50a is disposed substantially horizontally in line with the second pulley 40 and guides the rope 80 received from the second pulley 40. The third pulley 50a is are easily removable from the H-shaped cross beams 30c of the derrick structure 30. The plurality of fourth pulley 50b is disposed substantially vertically in line with the third pulley 50a.

The rope 80 is wound around the third pulley 50a and the fourth pulley 50b at a pre-determined number of turns and then connected to a securing element (not illustrated in Figures) configured on the derrick structure 30 proximal to the third pulley 50a. The fourth pulley 50b is vertically raised and lowered with respect to the third pulley 50a when the rope 80 is drawn in and drawn out from the winch system 10.

The jig 60 is detachably connected to the fourth pulley 50b for securely holding the transformer 128 (or the component) therein. The jig 60 comprises a holder 60a for securing the transformer 128 (or the component) and a hook 60b for securing the holder 60a with the fourth pulley 50b.

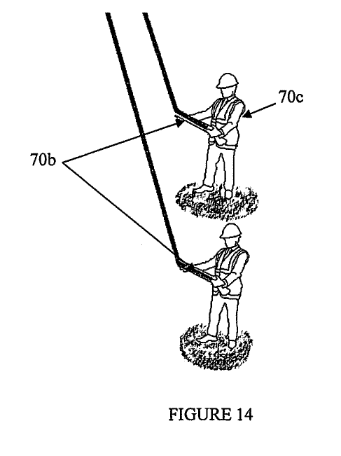

In an embodiment, the system 100 includes an anti-swaying mechanism which is typically a set of tagline ropes 70, as illustrated in FIG. 14. The tagline ropes 70 have their first ends 70a connected to the jig 60 such that the first ends 70 are spaced apart from each other. The second ends 80b of tagline ropes 70 is secured either by operator personnel 70c (illustrated in FIG. 13) standing on the ground or secured on a surface or ground. The two tagline ropes 70 prevents swaying of the jig 60 while being raised or lowered.

In accordance with one embodiment of the present disclosure also discloses a method for raising from and lowering to the ground level the transformer (or the component) of the wind turbine 200 to and from the nacelle 120 mounted on the tower 110. Initially, when a fault is detected in the transformer 128 (or the component) the winch system 10 is fixed on the ground so that movement of the winch system 10 on the ground is restricted. The yaw brake is applied that stops the movement of the nacelle 120 such that the nacelle 120 is fixed at a pre-determined orientation. The rotor brake is applied to stop rotation of the rotor, and hence the electricity generation system (also known as a processing unit power). The transformer 128 (or component) is dis-connected from the electricity generation system by operator personnel. In one embodiment, the components of the system 100 such as the winch system 10, the first pulley 20, the derrick structure 30, the pulley system 35, the jig 60 and the rope 80 are transported to the location of the wind turbine 200 by a vehicle such as a truck which can be easily reachable near the location of the wind turbine 200. The components of the system 100 such as the winch system 10, the first pulley 20, the derrick structure 30, the pulley system 35, the jig 60 and the rope 80 may be manually loaded and un-loaded from the vehicle or by using the nacelle hoist 127 or tripod hoist stand or pick and carry crane.

The interior of the nacelle 120 is accessed through an opening configured on at least one wall. The method of opening the nacelle 120 may be achieved by opening of the nacelle cover 120a which may be moved on a guide rail (not illustrated in Figures) either manually or automatically by hydraulic or pneumatic systems or lift up the nacelle cover 120a by dampers (not illustrated in Figures) or by dis-mantling the mechanical joints. Alternatively, the nacelle 120 may be cut to access the transformer 128. The nacelle 120 may be cut from its side faces or top face or bottom face and other combinations thereof. The nacelle 120 may be cut into various shapes that enables easy mounting of the derrick structure 30 therewithin. The nacelle hoist 127 is actuated to raise or lower the derrick structure 30 for mounting or de-mounting the derrick structure 30 within the nacelle 120. Alternatively, the derrick structure 30 may be raised or lowered by a pulley system or manual with rope system.

The derrick structure 30 is formed by assembling the plurality of leg post 30a, the top beam 30b, the H-shaped cross beams 30c and purlins 30d. Initially, the plurality of leg post 30a is lifted by the nacelle hoist 127 or pulley system or manual with rope system from ground to the nacelle 120 and then secured to the nacelle 120. Similarly, the top beam 30b is lifted by the nacelle hoist 127 or pulley system or manual with rope system from ground to the nacelle 120 and placed on the leg posts 30a. The H-shaped cross beams 30c are lifted from the ground by the nacelle hoist 127 or pulley system or manual with rope system and placed on the top beam 30b. The purlins 30d are lifted from the ground by the nacelle hoist 127 or pulley system or manual with rope system and placed on the H-shaped cross beams 30c. Fasteners are used to secure the plurality of leg post 30a, the top beam 30b, the H-shaped cross beams 30c and the purlins 30d respectively.

The first pulley 20 is mounted on the base of the tower 110, typically on the first pulley securing element 90. The second pulley 40 is fixed on the derrick structure 30 such that the second pulley 40 is substantially vertically in line with the first pulley 20. The third pulleys 50a is fixed on the derrick structure 30 such that the third pulleys 50a are substantially horizontally in line with the second pulley 40.

The rope 80, wound on the winch system 10, is drawed out from the winch system 10, either manually or automatically, and wound around the first pulley 20, the second pulley 40 and the third pulleys 50a and further wound around to the fourth pulleys 50b and then back to the third pulley 50a. The winding of the third pulleys 50a and the fourth pulleys 50b form a tackle arrangement. The number of windings between the third pulleys 50a and fourth pulleys 50b depends upon the load of the transformer 128 or the component which needs to be raised or lowered. The jig 60 is connected to the fourth pulleys 50b. The transformer 128 (or the component) which needs to be lowered for either replacing or repair is fixed on the component holding jig 60. In one embodiment, the transformer 128 (or the component) after being lowered may be transported by the vehicle to a location where the transformer 128 (or the component) may be repaired or a new transformer (or the component) may be transported near the wind turbine 200 by the pick and carry crane which may replace the faulty the transformer 128 (or the component). The first ends 70a of the two tagline ropes 70 is connected to the jig 60. The second ends 70b of the two tagline ropes 70 are secured either by operator personnel or on a support or on the ground. The two tagline ropes 70 prevent the swaying of the jig 60 while being raised or lowered. The winch system 10 is then actuated so that the rope 80 lowers or raises the component holding jig 60.

After, the raising and lowering of the transformer 128 (or the component) which is fitted in the jig 60 is completed, the system 100 is dismantled from the wind turbine 200. The two tagline ropes 70 are dismantled from the component holding jig 60 and the jig 60 is dismantled from the fourth pulleys 50b. The rope 80 is un-wound from the fourth pulleys 50b, the third pulleys 50a, the second pulley 40 and the first pulley 20 and wound by the winch system 10, either manually or automatically. The third pulleys 50a and the second pulley 40 are dismantled from the derrick structure 30. The derrick structure 30 is dismantled and is lowered from the nacelle 120 to the ground by the nacelle hoist 127. The first pulley 20 is dismantled from the base of the tower 110. The nacelle cover 120a is then closed. In case if the nacelle 120 was cut (not illustrated in Figures) to access the transformer 128 (or the component), thenafter the nacelle cover 120a is refixed in the cut and may be clamped by clamps and fastners followed by applying resin and fiber glass on the cover joints (not illustrated in Figures). Also, the putty is applied to enclose the cut and then typically two coats of paint is applied to match with the remaining portion of the nacelle 120 or follow as per nacelle cover manufacturer process.

### TECHNICAL ADVANCES AND ECONOMICAL SIGNIFICANCE

The system and method for raising and lowering a component of a wind turbine of the present disclosure described herein above has several technical advantages including but not limited to the realization of:
a system for raising and lowering a component of a wind turbine without usage of crane; and
a system for raising and lowering a component of a wind turbine that is comparatively less capital intensive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1) A system for raising from and lowering to the ground level a component of a wind turbine to and from a nacelle mounted on a tower, said system comprising:
a winch system disposed on the ground in the vicinity of the tower;
a first pulley configured to be fitted near the base of the tower;
a derrick structure configured to be fitted in the nacelle;
a pulley system including:
a set of fixed pulleys configured to be fitted to said derrick structure; and
a set of movable pulleys configured to be fitted to said fixed pulleys;
a jig configured to be coupled to said set of movable pulleys, said jig configured for holding the component; and
a rope wound around a drum of said winch system and coiled around said first pulley, said set of fixed pulleys, said set of movable pulleys and secured to a securing element configured on said derrick structure proximal to said set of fixed pulleys.

2) The system as claimed in claim 1, wherein said system includes an anti swaying mechanism connected to the jig for reducing swaying of the jig while being raised or lowered.

3) The system as claimed in claim 1, wherein said derrick structure includes
a plurality of leg posts adapted to be fitted in the nacelle;
a top beam secured to said leg posts;
a plurality of H-shaped cross beams transversely secured to said top beam for securing said second pulley and said third pulleys there-between; and
a pair of purlins transversely secured to said of H-shaped cross beams.

4) The system as claimed in claim 1, wherein said jig includes a holder and a hook, said holder configured to hold said component therewithin and said hook configured to couple said holder with said set of movable pulleys.

5) The method for raising from and lowering to the ground level a component of a wind turbine to and from a nacelle mounted on a tower, said method comprising:
fixing a winch system on the ground in the vicinity of said tower;
fixing said derrick structure within said nacelle;
mounting a first pulley near the base of said tower,
mounting a set of fixed pulleys on said derrick structure;
connecting a rope between said winch system, said first pulley, said set of fixed pulleys and a set of movable pulleys and fixing the end of the rope to a securing element fitted near the fixed pulleys on the derrick structure;
fixing a jig to said set of movable pulleys;
fixing the component on said jig; and
actuating said winch system for drawing in said rope and lifting a component from the ground level upto the nacelle and drawing out said rope for lowering a component from said nacelle to the ground level.

6) The method as claimed in claim 5, wherein said derrick structure is raised from and lowered to the ground level to and from the nacelle by a nacelle hoist.

7) The method as claimed in claim 5, wherein said derrick structure is raised from and lowered to the ground level to and from the nacelle by a pulley system or a manual rope system.

8) The method as claimed in claim 5, wherein the step of fixing of said derrick structure includes the steps of:
fitting a plurality of leg posts within said nacelle;
fitting a top beam on said leg posts;
fitting a H-shaped cross beams on said top beam; and
fitting a pair of purlins on said H-shaped cross beams.

9) The method as claimed in claim 5, further includes connecting an anti swaying element to said jig.

10) The method as claimed in claim 5, further includes connecting a first pulley securing element to said tower for securing said first pulley.
